(19) United States
(12) Patent Application Publication
(10) Pub. No.: US 2023/0145917 A1
(43) Pub. Date: May 11, 2023

(54) METHOD FOR THE PRODUCTION OF CEMENT CLINKER

(71) Applicant: thyssenkrupp Industrial Solutions AG, Essen (DE)

(72) Inventors: Eike WILLMS, Dortmund (DE); Oliver MAIER, Muenster (DE)

(73) Assignee: thyssenkrupp Industrial Solutions AG, Essen (DE)

(21) Appl. No.: 17/916,636

(22) PCT Filed: Apr. 6, 2021
(86) PCT No.: PCT/EP2021/058930

§ 371 Date: Oct. 3, 2022

(30) Foreign Application Priority Data
Apr. 8, 2020 (BE) 2020/5227
Apr. 8, 2020 (DE) 10 2020 204 520.8

(51) Int. Cl. C04B 7/43; C04B 7/44; C04B 7/47; F27D 19/00; F27B 7/42

(52) U.S. Cl. CPC C04B 7/432; C04B 7/434; C04B 7/4407; C04B 7/47; F27D 19/00; F27B 7/42; F27D 2019/0018; F27M 2003/03; F27D 2019/0043; F27D 2019/004

(57) ABSTRACT

A process for producing cement clinker, may involve preheating raw meal in a preheater, calcining the preheated raw meal in a calciner, and burning the preheated and calcined raw meal in a furnace to give cement clinker. The furnace may be supplied with a combustion gas having an oxygen content, and the temperature within the furnace is ascertained. The process may involve cooling the cement clinker in a cooler. The oxygen supply to the furnace is under closed-loop control as a function of the temperature ascertained within the furnace. The temperature ascertained is compared with a target value and, in the event of any variance of the temperature ascertained from the target value, the oxygen supply to the furnace and/or to the calciner is increased or decreased. The target value is adjusted depending on a particle size distribution and/or a lime standard.

The invention relates to a process for producing cement clinker.

The prior art discloses introducing oxygenous gas for supply of fuel into the rotary furnace or the calciner of a cement production plant. For reduction of the amount of offgas, and in order to be able to dispense with complex purification methods, the use of a combustion gas having a maximum oxygen content is known, for example, from DE 10 2018 206 673 A1, such that the CO2 content in the offgas is high. DE 10 2018 206 673 A1 discloses the introducing of an oxygen-rich gas into the cooler inlet region for preheating of the gas and cooling of the clinker.

One indicator of the composition and quality of cement clinker is the lime standard. For instance, in the case of a lime standard of 95, the proportion of alite (tricalcium silicate, C3S) is typically 60-65% and the proportion of belite (dicalcium silicate, C2S) 10-20%, with establishment of the clinker mineralogy via the raw meal composition and the chosen burning conditions. The cement produced from the abovementioned process typically has a considerable proportion of belite (dicalcium silicate). This typically leads to low early cement strengths and high energy expenditure in the grinding of the cement.

It is therefore an object of the present invention to overcome the abovementioned disadvantages and to specify a process for energy-efficient production of cement, wherein the cement optimally has a high proportion of alite (tricalcium silicate).

This object is achieved in accordance with the invention by a process having the features of independent apparatus claim 1 and by an apparatus having the features of independent process claim 10. Advantageous developments will be apparent from the dependent claims.

A process for producing cement clinker, in a first aspect, comprises the steps of:
preheating raw meal in a preheater,
calcining the preheated raw meal in a calciner,
burning the preheated and calcined raw meal in a furnace to give cement clinker,
wherein the furnace is supplied with a combustion gas having an oxygen content and the temperature within the furnace is ascertained, and
cooling the cement clinker in a cooler.

The process further comprises controlling the oxygen supply to the furnace as a function of the temperature ascertained within the furnace by open-loop/closed-loop control. The oxygen supply should be understood to mean the amount, especially the volume, of oxygen that flows into the furnace per unit time.

An increase in the lime standard is possible, for example, by establishing a higher temperature in the sintering zone with the same dwell time of the material to be burnt in the furnace. In this case, given the same free lime contents in the product, a higher alite content is achieved. Alite-rich clinkers achieve better strength properties in cement compared to lower-alite clinkers. Since the belite component is more difficult to grind than the alite component, the higher alite content additionally results in a decrease in the electrical energy expenditure necessary for the grinding of cement clinker. The lime standard in particular can be adjusted by the above-described process.

The combustion gas supplied to the furnace has an oxygen content, for example, of more than 20.5%, especially more than 30%, preferably more than 95%. The combustion gas consists, for example, entirely of pure oxygen, with the oxygen content of the combustion gas being 100%. For open-loop/closed-loop control of the oxygen supply, for example, the oxygen content of the combustion gas is increased or reduced, in which case, for example, the combustion gas stream into the furnace remains constant. It is likewise conceivable to increase or to reduce the combustion gas stream in order to increase or to reduce the oxygen supply to the furnace. For example, for closed-loop/open-loop control of the oxygen supply to the furnace, the combustion gas stream and/or the oxygen content in the combustion gas stream is increased or reduced.

The furnace is preferably a rotary furnace with a rotary tube rotatable about its longitudinal axis, which is preferably slightly inclined in conveying direction of the material to be combusted, such that the material is moved in conveying direction as a result of the rotation of the rotary tube and gravity. The furnace is preferably has, at one end, a material inlet for introduction of preheated raw meal and, at its opposite end from the material inlet, a material outlet for discharge of the burnt clinker into the cooler. At the material outlet end of the furnace is preferably disposed the furnace head which has the burner for burning of the material and preferably a fuel inlet for introduction of fuel into the furnace, preferably to the burner. The furnace preferably has a sintering zone in which the material is at least partly melted, and especially has a temperature of 1500° C. to 1800° C., preferably 1450° C. to 1700° C. The sintering zone comprises, for example, the furnace head, preferably the rear third or the rear two thirds of the furnace in conveying direction of the material. The temperature is preferably ascertained within the sintering zone and/or the material inlet of the furnace.

The combustion gas is introduced, for example, directly into the furnace head in full or in part, with the furnace head having, for example, a combustion gas inlet. The combustion gas is preferably introduced into the furnace fully or partly via the material outlet of the furnace.

The material outlet of the furnace is preferably adjoined by the cooler for cooling of the cement clinker.

The closed-loop/open-loop control of the oxygen supply to the furnace as a function of the temperature within the furnace, especially the sintering zone or the material inlet of the furnace, offers the advantage of simple control of the furnace temperature, preferably with establishment of stoichiometric or superstoichiometric combustion.

In a first embodiment, the temperature within the furnace is measured directly by means of a temperature measurement device or indirectly by means of process parameters, such as, in particular, the nitrogen oxide content in the furnace, the power consumption of the furnace, the oxygen content in the furnace, the fuel supply to the furnace, the outside temperature of the furnace wall and/or the supply of raw meal to the preheater.

The process parameters are preferably each ascertained by means of a respective measuring device and preferably transmitted to the control device. The control device is especially designed such that it uses one or more of the parameters ascertained to ascertain the temperature within the furnace. In particular, the control device is designed for open-loop and/or closed-loop control of the temperature.

In a further embodiment, the oxygen supply to the furnace and to the calciner is adjusted such that there is superstoichiometric, especially near-stoichiometric, combustion in the calciner and the furnace. The sum total of the oxygen supply to the furnace and the oxygen supply to the calciner is the total amount of oxygen in the process. An oxygen measurement device is preferably disposed within the preheater, such that the oxygen content of the gas flowing through the preheater is ascertained. The control device is preferably designed such that it uses the oxygen content ascertained in the gas flowing through the preheater to ascertain the total amount of oxygen in the process. In particular, the division of the total amount of oxygen in the process between the calciner and the furnace is preferably controlled by the control device as a function of the oxygen concentration ascertained in the gas flowing through the preheater, such that there is preferably near-stoichiometric or superstoichiometric combustion of the fuel in the furnace and calciner. The total amount of oxygen in the process ascertained is divided between the furnace and the calciner as a function of the temperature ascertained within the furnace, especially within the sintering zone and/or the material inlet of the furnace. The control device is preferably designed such that it divides the amount of oxygen that flows into the furnace and/or the calciner in such a way that the sum total corresponds to the total amount of oxygen needed for superstoichiometric combustion. The oxygen supply to the calciner and the furnace is preferably additionally under closed-loop control as a function of the amount of fuel supplied to the furnace and/or the calciner and/or the amount of raw meal introduced into the preheater.

The temperature ascertained is compared to a target value and, in the event of any variance of the temperature ascertained from the target value, the oxygen supply to the furnace and/or to the calciner is increased or reduced. The target value is a target temperature value that constitutes the desired temperature within the sintering zone and/or the material inlet of the furnace.

The target value is adjusted depending on the particle size distribution and/or the lime standard. Different target temperature values should preferably be assigned to different lime standards. For example, the target value is 1360° C. to 1520° C. in the case of a lime standard of 95 or the target value is, for example, 1480° C. to 1620° C. in the case of a lime standard of 100 or the target value is, for example, 1580° C. to 1680° C. in the case of a lime standard of 104.

It is likewise conceivable that different target values are assigned to different particle size distributions. A coarse particle size distribution requires a higher target value compared to a finer particle size distribution. A raw meal having a relatively coarse particle size distribution has, for example, about 20% to 25% or more residue to 90 μm.

The establishment of a corresponding temperature target value ensures that the raw meal reacts fully with the same dwell time as usual in the sintering zone, and that the corresponding clinker minerals, especially alite, are formed. This leads to a considerable saving of electrical grinding energy in production of the cement raw meal.

The assignment of the target value to particular particle size distributions and/or lime standards is preferably determined in advance and especially recorded in the control device.

The total amount of oxygen in the process is preferably supplied to the furnace, wherein the combustion gas supply to the furnace has an oxygen content of more than 95%, such that the combustion in the furnace is superstoichiometric and has an oxygen content of 50% to 70% in the furnace offgas. The furnace offgas is then fed to the calciner and forms the entirety of the combustion gas for the calciner.

It is likewise conceivable that the furnace is supplied with only a portion of the total amount of oxygen in the process and the combustion gas from the calciner is formed merely partly from the furnace offgas and a portion of the combustion offgas is supplied directly to the calciner.

In both the aforementioned cases, the control device is set up as follows: if the temperature ascertained exceeds the target value, the amount of combustion gas and/or the amount of oxygen in the combustion gas is preferably increased. If the temperature ascertained goes below the target value, the amount of combustion gas and/or the amount of oxygen in the combustion gas is reduced when the target temperature ascertained goes below the target value. The inventors have found that an excess amount of combustion gas causes a drop in temperature within the furnace since the interior of the furnace is cooled by the excess combustion gas which is not converted in the combustion process.

In a further embodiment, the furnace is supplied with a fuel and the supply of the fuel is under closed-loop control as a function of the temperature ascertained within the furnace. The fuel supply is preferably increased or reduced when the temperature ascertained varies from the predetermined target value. If the temperature ascertained exceeds the predetermined target value, the fuel supply is reduced, for example. If the temperature ascertained goes below the predetermined target value, the fuel supply is increased, for example. It is likewise conceivable that the fuel supply is under closed-loop control as a function of the temperature ascertained in the furnace inlet and/or the amount of nitrogen oxides in the preheater offgas.

In a further embodiment, the cooler has a cooling gas space through which a cooling gas stream for cooling of the bulk material can flow in crossflow, wherein the cooling gas space comprises a first cooling gas space section with a first cooling gas stream and a second cooling gas space section which adjoins the latter in conveying direction of the clinker and has a second cooling gas stream, wherein the combustion gas supplied to the furnace is formed fully or partly by the first cooling gas stream and wherein the supply of the combustion gas is under closed-loop control as a function of the temperature ascertained within the furnace. Preferably, the supply of the combustion gas is increased or reduced when the temperature ascertained varies from the predetermined target value. If the temperature ascertained exceeds the predetermined target value, the supply of the combustion gas is reduced, for example. If the temperature ascertained goes below the predetermined target value, the supply of the combustion gas is increased, for example.

The cooler has a conveying device for conveying the bulk material in conveying direction to the cooling gas space. The cooling gas space comprises a first cooling gas space section with a first cooling gas stream and a second cooling gas space section which adjoins the latter in conveying direction of the bulk material and has a second cooling gas stream. The cooling gas space is preferably bounded at the top by a cooling gas space roof and at the bottom by a dynamic and/or static grid, preferably the bulk material lying thereon. The cooling gas space is especially the entire cooler space through which cooling gas flows above the bulk material. The cooling gas stream flows through the dynamic and/or static grid, especially through the conveying device, through the bulk material and into the cooling gas space. The first cooling gas space section is preferably disposed directly beyond the cooler inlet, especially the material outlet from the furnace, in flow direction of the bulk material to be cooled. The clinker preferably falls out of the furnace into the first cooling gas space section.

The first cooling space section preferably has a static grid and/or dynamic grid disposed beneath the material outlet from the furnace, such that the clinker exiting from the furnace falls onto the static grid under gravity. The static grid is, for example, a grid set at an angle to the horizontal of 10° to 35°, preferably 12° to 33°, especially 13° to 21°, through which the first cooling gas stream flows from beneath. What flows into the first cooling gas space section is preferably exclusively the first cooling gas stream, which is accelerated, for example, by means of a ventilator. The second cooling gas space section adjoins the first cooling gas space section in conveying direction of the bulk material and is preferably separated for gas purposes from the first cooling gas space section by means of a dividing apparatus. What flows into the second cooling gas space section is preferably exclusively the second cooling gas stream, which is accelerated, for example, by means of a ventilator.

The second cooling gas space section preferably has a dynamic grid for conveying of the bulk material through the cooling gas space. The dynamic grid comprises a conveying unit for transport of the material in conveying direction, with the conveying unit having, for example, a ventilated floor through which cooling gas can flow and which has a multitude of flow openings for introduction of cooling gas. The cooling gas is provided, for example, by ventilators disposed beneath the ventilated floor, such that a cooling gas, for example cooling gas, flows through the bulk material to be cooled in a transverse flow to the conveying direction. The ventilated floor preferably forms a plane on which the bulk material lies. The conveying unit additionally has a multitude of conveying elements that are movable in conveying direction and counter to conveying direction. The ventilated floor is preferably formed partly or fully by conveying elements which, arranged alongside one another, form a plane for accommodation of the bulk material.

The first cooling gas stream flowing through the first cooling gas space section is, for example, pure oxygen or a gas having a proportion of less than 35% by volume, especially less than 21% by volume, preferably 15% by volume or less, of nitrogen and/or argon and/or an oxygen content of more than 20.5%, especially more than 30%, preferably more than 95%. The first cooling gas section preferably directly adjoins the material outlet from the furnace, preferably the furnace head of the furnace, such that the cooling gas is heated in the cooler and then flows into the rotary furnace and is used as combustion gas. The second cooling gas stream is, for example, air.

The cooler preferably has a dividing apparatus for separation of the cooling gas sections from one another for gas purposes.

In a further embodiment, the furnace has a multitude of combustion gas inlets through which the combustion gas is introduced into the furnace, wherein the supply of combustion gas to each of the respective combustion gas inlets is under closed-loop control as a function of the temperature ascertained within the furnace. The combustion gas inlets are preferably disposed in the sintering zone of the furnace or connected thereto via conduits or guiding means. The supply of combustion gas is adjusted, for example, by means of supply, such as valves, restrictors or throttles.

In a further embodiment, the amount of fuel introduced into the furnace and calciner, the proportion of nitrogen oxides in the furnace offgas, the proportion of oxygen in the furnace offgas, the amount of raw meal introduced into the preheater is ascertained and the oxygen supply to the furnace and/or the calciner is under closed-loop control as a function of at least one of the values ascertained.

Preferably, the material temperature within the sintering zone is 1450° C. to 1800° C., preferably 1500° C. to 1700° C. The gas temperature, especially the temperature on the inside of the furnace wall, within the sintering zone is preferably 2000° C. to 2600° C., preferably 2100° C. to 2500° C. The position of the sintering zone in the furnace is ascertained, for example, by ascertaining the outside temperature of the furnace wall at a multitude of measurement points and preferably creating a temperature profile over the outer wall of the furnace.

The ascertaining of the temperature within the furnace, in a further embodiment, comprises the ascertaining of the temperature of the gas phase, of the inner wall surface and/or of the clinker within the sintering zone and all the material inlet of the furnace, with the ascertainment of the temperature in a contactless manner, for example. It is likewise conceivable to ascertain the temperature by means of a thermocouple.

The temperature within the furnace is preferably ascertained by means of one or more temperature measurement devices mounted in the sintering zone and/or the material inlet of the furnace. The temperature measurement device is, for example, a pyrometer. The pyrometer is preferably designed for contactless measurement of temperature, with the measurement device preferably working in the short-wave and medium-wave light range. For example, the measurement device is designed such that it ascertains the temperature on the inside of furnace wall and/or of the clinker within the furnace. The measurement device is, for example, an infrared measurement device (NIR, MIR).

The invention also encompasses a cement production plant having
a preheater for preheating raw meal,
a calciner for calcining the preheated raw meal,
a furnace for burning the raw meal to give cement clinker, wherein the furnace has a temperature measurement device for ascertaining the temperature within the furnace and a combustion gas inlet for introducing a combustion gas with an oxygen content into the furnace, and
a cooler for cooling the cement clinker.

The cement production plant additionally has a control device which is connected to the temperature measurement device and the combustion gas inlet and is designed such that it controls the oxygen supply to the furnace depending on the temperature ascertained within the furnace.

The above-described details and advantages of the process for producing cement clinker are also applicable to the cement production plant in a corresponding manner for apparatus purposes.

The combustion gas inlet preferably comprises means of closed-loop control of the combustion gas stream into the furnace, for example a flap, restrictor, throttle, valves, or a ventilator for accelerating the combustion gas into the furnace. The control device is especially connected to the means, such that it controls the combustion gas stream into the furnace.

In a further embodiment, the preheater has an oxygen measurement device connected to the control device for ascertaining the oxygen content of the gas flowing through the preheater, and wherein the control device is designed such that it controls the oxygen supply to the calciner and the furnace in such a way that there is stoichiometric or superstoichiometric, especially near-stoichiometric, combustion. In particular, the oxygen measurement device is disposed upstream of the last cyclone stage in the preheater in flow direction of the gas. The first cyclone stage if the uppermost cyclone stage into which the raw meal is introduced. The last cyclone stage is directly upstream of the material inlet of the furnace. It is likewise conceivable that the oxygen measurement device is disposed downstream of the second cyclone, preferably downstream of the calciner. The oxygen measurement device may also be connected downstream of the preheater.

The control device is preferably connected to the oxygen measurement device in such a way that the oxygen measurement device transmits the oxygen concentration ascertained to the control device. The control device is preferably designed such that it compares the oxygen concentration ascertained to a predetermined target value and, in the event of any variance in the oxygen concentration from the target value, increases or reduces the oxygen supply to the calciner and/or to the furnace. For example, the control device is designed such that it increases the oxygen supply to the calciner and/or the furnace when the oxygen concentration ascertained goes below the target value. For example, the control device is designed such that it reduces the oxygen supply to the calciner and/or furnace when the oxygen concentration ascertained exceeds the target value.

The control device is designed such that it compares the temperature ascertained in the furnace to a target value and, in the event of any variance in the temperature ascertained from the target value, increases or reduces the oxygen supply to the furnace and/or to the calciner. For example, the control device is designed such that it increases the oxygen supply when the temperature ascertained exceeds the target value. For example, the control device is designed such that it increases the oxygen supply exceeds the target value. The target value is set depending on the particle size distribution and/or the lime standard.

In a further embodiment, the calciner and the furnace each have a means of supplying fuel respectively to the furnace and to the calciner, wherein the control device is connected to the at least one means and designed such that it controls the supply of fuel to the calciner and/or the furnace depending on the temperature ascertained within the furnace. The at least one means is, for example, a fuel conduit with a flap, throttle or valve that adjusts the flow rate of fuel through the conduit. For example, the control device is designed such that it reduces the fuel supply when the temperature ascertained exceeds the target value. In particular, the control device is designed such that it increases the fuel supply when the temperature ascertained goes below the target value.

In a further embodiment, the furnace has a multitude of combustion gas inlets through which the combustion gas is introduced into the furnace, wherein the control device is designed such that it controls the supply of combustion gas to each of the respective combustion gas inlets depending on the temperature ascertained within the furnace.

In a further embodiment, the temperature measurement device is designed to perform contactless temperature measurement on the inner surface of the furnace wall and/or on the clinker within the sintering zone.

### DESCRIPTION OF THE DRAWINGS

The invention is elucidated in detail hereinafter by multiple working examples with reference to the appended figures.

FIG. 1 shows a schematic diagram of a cement production plant with a control device according to one working example.

FIG. 2 shows a schematic diagram of a cement production plant with a control device according to a further working example.

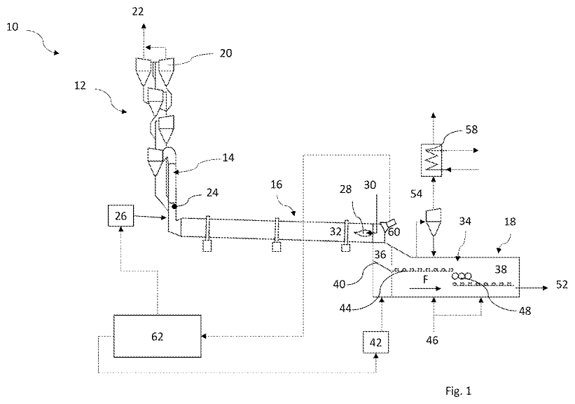

FIG. 1 shows a production plant 10 with a single-strand preheater 12 for preheating of raw meal, a calciner 14 for calcining the raw meal, a furnace 16, especially a rotary furnace for combusting the raw meal to clinker, and a cooler 18 for cooling the clinker burnt in the furnace 16.

The preheater 12 comprises a multitude of cyclones 20 for separation of the raw meal out of the raw meal gas stream. By way of example, the preheater 12 has five cyclones 20 arranged in four cyclone stages one below another. The preheater 12 has a material inlet (not shown) for introduction of the raw meal into the uppermost cyclone stage of the preheater 12 that comprises two cyclones 20. The raw meal flows successively through the cyclones 20 of the cyclone stages in countercurrent to the furnace offgas and/or calciner offgas and is heated as a result. The calciner 14 is disposed between the last and penultimate cyclone stages. The calciner 14 has a riser with at least one combustion site for heating of the raw meal, such that the raw meal is calcined in the calciner 14. In addition, the calciner 14 has a fuel inlet 24 for introducing fuel into the riser. The calciner 14 also has a combustion gas inlet 26 for introducing combustion gas into the riser of the calciner 14. The combustion gas is, for example, air, oxygen-enriched air, pure oxygen or a gas having an oxygen content of at least 85%. The calciner offgas is introduced into the preheater 12, preferably into the penultimate cyclone stage, and leaves the preheater 12 beyond the uppermost cyclone stage as preheater offgas 22.

Connected downstream of the preheater 12 in flow direction of the raw meal is the furnace 16, such that the raw meal preheated in the preheater 12 and calcined in the calciner 14 flows into the furnace 16. The material inlet 25 of the furnace 16 is connected directly to the riser of the calciner 14, such that the furnace offgas flows into the calciner 14 and subsequently into the preheater 12. The furnace 16 is, by way of example, a rotary furnace having a rotary tube rotatable about its longitudinal axis, arranged at a slightly declining angle. The furnace 12 has a burner 28 and a corresponding fuel inlet 30 at the material outlet end within the rotary tube. The material outlet from the furnace 16 is disposed at the opposite end of the rotary tube from the material inlet 25, such that the raw meal is conveyed within the rotary tube by the rotation of the rotary tube in the direction of the burner 28 and of the material outlet. The raw meal is burnt within the furnace 16 to give cement clinker, with the raw meal essentially undergoing the phases of clinker formation in the rotary tube and being formed in about the last third of the furnace C3S in meal flow direction. This permanently forms, in the last third of the furnace, a layer of hard crust of thickness about 250 mm which, in chemical/mineralogical terms, corresponds to cement clinker. The region of the furnace 16 in which C3S is formed is referred to hereinafter as sintering zone 32. The sintering zone 32 comprises the far region of the rotary tube on the material outlet side, preferably the rear third material flow direction, especially the rear two thirds of the rotary tube. The sintering zone 32 is preferably the region of the furnace 16 in which the temperature is about 1450° C. to 1800° C., preferably 1500° C. to 1700° C.

Following on from the material outlet of the furnace 16 is the cooler 18 for cooling of the clinker. The cooler 18 has a cooling gas space 34 in which the clinker is cooled by a cooling gas stream. The clinker is conveyed in conveying direction F through the cooling gas space 34. The cooling gas space 34 has a first cooling gas space section 36, and a second cooling gas space section 38 which follows on in conveying direction F from the first cooling gas space section 36. The furnace 16 is connected to the cooler 18 via the material outlet of the furnace 16, such that the clinker burnt in the rotary furnace 20 falls into the cooler 18.

The first cooling gas space section 36 is disposed beneath the material outlet of the furnace 16, such that the clinker falls from the furnace 16 into the first cooling gas space section 36. The first cooling gas space section 36 constitutes an intake region for the cooler 18 and preferably has a static grid 40 that receives the clinker exiting from the furnace 16. The static grid 40 is especially disposed entirely within the first cooling gas space section 36 of the cooler 10. The clinker preferably falls out of the furnace 16 directly onto the static grid 40. The static grid 40 extends preferably completely at an angle of 10° to 35°, preferably 14° to 33°, especially 21 to 25, to the horizontal, such that the clinker slides along the static grid 40 in conveying direction.

Following on from the first cooling gas space section 36 is the second cooling gas space section 38 of the cooler 18. In the first cooling gas space section 36 of the cooler 18, the clinker is especially cooled to a temperature of less than 1100° C., the cooling being effected in such a way that liquid phases present in the clinker are fully solidified to solid phases. When it leaves the first cooling gas space section 36 of the cooler 18, the clinker is preferably completely in the solid phase and at a temperature of not more than 1100° C. In the second cooling gas space section 38 of the cooler 18, the clinker is cooled down further, preferably to a temperature of less than 100° C. The second cooling gas stream can preferably be divided into multiple gas substreams having different temperatures.

The static grid of the first cooling gas space section 36 has, for example, passages through which a cooling gas enters the cooler 18 and the clinker. The cooling gas is generated, for example, by means of at least one ventilator disposed beneath the static grid 40, such that a first cooling gas stream 42 flows from below through the static grid into the first cooling gas space section 36. The first cooling gas stream 42 is, for example, pure oxygen or a gas having a proportion of 15% by volume or less of nitrogen and a proportion of 50% by volume or more of oxygen. The first cooling gas stream 42 flows through the clinker and then flows into the furnace 16. The first cooling gas stream forms, for example, a portion or the entirety of the combustion gas for the furnace 16. The high proportion of oxygen in the combustion gas leads to a preheater offgas consisting essentially of CO2 and water vapor, and has the advantage that it is possible to dispense with complex downstream purification methods for offgas cleaning. Also achieved is a reduction in the volumes of process gas, such that the plant can have considerably smaller dimensions.

Within the cooler 18, the clinker to be cooled is moved in conveying direction F. The second cooling gas section 38 preferably has a dynamic, especially movable, grid 44 which follows on from the static grid 40 in conveying direction F. The dynamic grid 44 especially has a conveying unit that transports the clinker in conveying direction F. The conveying unit is, for example, a moving floor conveyor having a multitude of conveying elements for transport of the bulk material. The conveying elements in a moving floor conveyor are a multitude of planks, preferably grid planks, that form a ventilated floor. The conveying elements are disposed alongside one another and are movable in conveying direction F and counter to conveying direction F. It is preferably possible for cooling gas stream to flow through the conveying elements in the form of conveying planks or grid planks, and these are disposed over the entire length of the second cooling gas section 38 of the cooler 18 and form the surface on which the clinker lies. The conveying unit may also be a moving conveyor, in which case the conveying unit has a stationary ventilated floor through which cooling gas stream can flow and a multitude of conveying elements movable relative to the ventilated floor. The conveying elements of the moving conveyor are preferably disposed above the ventilated floor and have entrainers that run transverse to conveying direction. For transport of the clinker along the ventilated floor, the conveying elements are movable in conveying direction F and counter to conveying direction F. The conveying elements of the moving conveyor and of the moving floor conveyor may be movable by the “walking floor principle”, wherein the conveying elements are all moved simultaneously in conveying direction and non-simultaneously counter to conveying direction. Alternatively, other conveying principles from bulk material technology are also conceivable.

Beneath the dynamic grid 44 are disposed, by way of example, a multitude of ventilators by means of which the second cooling gas stream 46 is blown from below through the dynamic grid 44. The second cooling gas stream 46 is, for example, air.

Following on from the dynamic grid 44 of the second cooling gas space section 38 in FIG. 1, by way of example, is a comminuting device 48. The comminuting device 48 is, for example, a crusher having at least two crusher rolls that are rotatable in opposing directions and a crusher nip formed between them, in which the comminution of the material takes place. Following on from the comminuting device 48 is a further dynamic grid 50 beneath the comminuting device 48. The cold clinker 52 on departure from the cooler 18 is preferably at a temperature of 100° C. or less.

For example, cooler output air 54 is removed from the second cooling gas space section 38 and guided into a separator 56, for example a cyclone, for separation of solids. The solids are fed back to the cooler 18 by way of example. Connected downstream of the separator 56 is an air-air heat exchanger 58, such that the cooling output air preheats air within the heat exchanger 58, and this is fed, for example, to a raw mill.

Within the furnace 16, preferably within the sintering zone 32 of the furnace 16, is disposed a temperature measurement device 60 for ascertaining the temperature of the gas and/or the clinker within the furnace 16. The temperature measurement device 60 is connected to a control device 62, such that the temperature data ascertained are transmitted to the control device 62. The control device 62 is connected to the combustion gas inlet 26 of the calciner 14 for control of the amount of combustion gas that flows into the calciner 14. The control device 62 is preferably designed such that it controls the amount of the first cooling gas stream 42 entering the first cooling gas space section 36 of the cooler 18. The control device 62 is especially designed such that it controls the amount of combustion air into the furnace and/or the amount of combustion air into the calciner, preferably as a function of the temperature ascertained within the furnace 16, especially within the sintering zone 32. In particular, the control device 62 is set up such that it controls the amount of oxygen which is fed to the calciner 14 and/or the furnace 16. The amount of oxygen to the calciner 14 or the furnace 16 is adjusted, for example, via the amount of combustion gas or the oxygen content in the combustion gas. The control device 62 is preferably connected to one ventilator or a multitude of ventilators for acceleration of the combustion gas from the furnace 16 and/or the calciner 14, such that the control device controls the speed of the ventilator, for example.

It is likewise conceivable that the control device 62 is connected to a respective inlet for introduction of combustion gas into the calciner 14 or the furnace 16, in such a way that it controls the opening size of the respective inlet. It is likewise conceivable that the control device 62 is connected to an oxygen conduit for guiding oxygen into the combustion gas and controls the amount of oxygen flowing into the combustion gas via the conduit. The oxygen is preferably provided either in gaseous or liquid form from a pressure vessel. The gas is guided, for example, from a liquid oxygen source into an evaporator, where it is converted to liquid phase. In the case of gaseous provision either from the evaporator or a gaseous source under pressure, preference is given to generating a supply pressure, such that only a low level of compression/acceleration work has to be generated by a ventilator or compressor. Preferably, the conduit to the respective inlets in the furnace is adjusted by one or more valves. For example, means of measuring the flow of oxygen are provided in the section of pipeline.

The control device 62 is preferably designed such that it compares the temperature ascertained within the sintering zone 32 of the furnace 16 with a predetermined target value and, in the event of any variance of the temperature ascertained from the target value, increases or reduces the amount of combustion gas, especially the amount of oxygen, that flows into the furnace 16 and/or the calciner 14. For example, the control device 62 is designed such that it increases the amount of combustion gas, especially the amount of oxygen in the combustion gas, in the event that the target value is exceeded by the temperature ascertained. The control device 62 is preferably set up such that it reduces the amount of combustion gas, especially amount of oxygen in the combustion gas, in the event that the temperature ascertained goes below the target value. The inventors have found that an excess amount of combustion gas causes the temperature within the furnace 16 to fall, since the interior of the furnace is cooled by the excess combustion gas which is not converted in the combustion process. In principle, superstoichiometric combustion can be assumed here.

Such control of the furnace temperature enables the production of a clinker having a desired proportion of alite in a simple manner.

The predetermined target value for the temperature within the furnace, especially within the sintering zone 32, permits the establishment of a high lime standard in the raw meal, and consequently in the cement clinker, and is thus crucial for the product quality. In spite of a high lime standard of, for example, more than 100-105, the higher sintering zone temperatures than usual can result in complete or virtually complete reaction of belite with calcium oxide to give alite. The resulting cement clinker has a proportion of alite of at least 65%, especially more than 75%, but preferably of 85%, while the proportions of belite and unconverted calcium oxide (free lime) approach zero.

For a CEM I with 95-100% clinker content according to DIN EN 197-1, even in the case of low cement finenesses of less than 600 m²/kg according to Blaine, but preferably less than 500 m²/kg according to Blaine, this results in 2-day initial strengths of well above 30 MPa, especially above 40 MPa, but preferably above 50 MPa, and 28-day standard strengths of well above 50 MPa, especially above 60 MPa, but preferably above 70 MPa.

Superstoichiometric combustion is established by adjusting the entire oxygen supply to the combustion processes, especially the oxygen supply to the calciner 14 and the oxygen supply to the furnace 16. There is preferably a measurement device for ascertaining the oxygen content in the preheater 12, preferably in the preheater gas, disposed beyond the second cyclone stage in gas flow direction, with the first cyclone stage being the uppermost cyclone stage. The amount of oxygen which is supplied overall to the combustion processes within the calciner 14 and the furnace 16 is controlled as a function of the oxygen content ascertained downstream of the second cyclone stage, the amount of fuel which is supplied to the combustion processes and preferably the amount of raw meal which is introduced into the preheater, such that there is superstoichiometric combustion within the calciner 14 and the furnace 16.

The total amount of oxygen ascertained is divided between the furnace 16 and the calciner 14 as a function of the temperature ascertained within the furnace 16, especially within the sintering zone 32. The control device 62 is designed such that it divides the amount of oxygen that flows into the furnace 16 and/or the calciner 14 in such a way that the sum total corresponds to the total amount of oxygen needed for superstoichiometric combustion.

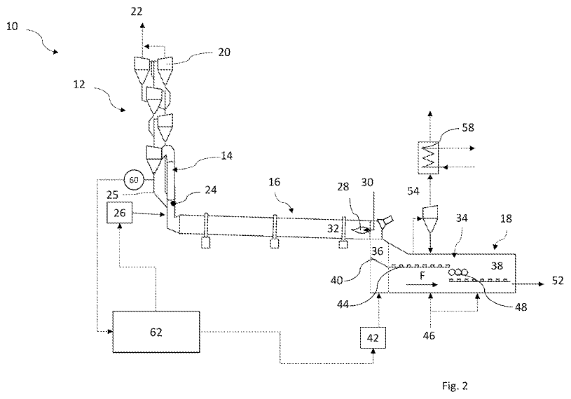

FIG. 2 shows a further working example of a cement production plant, which corresponds for the most part to the working example of FIG. 1, and wherein identical elements are given the same reference numerals. By contrast with the working example of FIG. 1, the temperature measurement device 60 is disposed by way of example in the material inlet 25 of the furnace 16. The temperature measurement device 60 is preferably designed such that it ascertains the temperature of the material entering the furnace 16. The temperature ascertained is transmitted to the control device 62 and serve especially for closed-loop control of the supply of oxygen to the furnace and/or the calciner, as described above with reference to FIG. 1. It is likewise conceivable that the temperature measurement device 60 is designed such that it both ascertains the temperature in the material inlet 25 and the sintering zone 32 of the furnace 16 and transmits it to the control device 62.

In addition to the temperature in the sintering zone 32 and/or the material inlet 25 of the furnace 16, it is likewise conceivable that further parameters, for example the fuel supply to the calciner 14 and/or the furnace 16, the raw meal supply to the preheater 12 or the proportion of nitrogen oxides in the furnace offgas, the calciner offgas or the preheater offgas, are ascertained and transmitted to the control device 62. The oxygen supply to the furnace 16 and/or the calciner is controlled, for example, as a function of the aforementioned parameters.

For example, the power consumption of the furnace 16 is additionally ascertained and transmitted to the control device. This gives an indication of the furnace operation and the need for a control intervention. For example, the oxygen supply to the furnace is additionally under closed-loop control as a function of the power consumption of the furnace 16 by the control device 62.

### LIST OF REFERENCE NUMERALS

10 cement production plant

12 preheater

14 calciner

16 furnace

18 cooler

20 cyclone

22 preheater offgas

24 fuel inlet of the calciner

25 material inlet into the furnace

26 combustion gas inlet of the calciner

28 burner of the furnace

30 fuel inlet of the furnace

32 sintering zone

34 cooling gas space

36 first cooling gas space section

38 second cooling gas space section

40 static grid

42 first cooling gas stream

44 dynamic grid

46 second cooling gas stream

48 comminution device

50 dynamic grid 50

52 cold clinker

54 cooler output air

56 separator

58 heat exchanger

60 temperature measurement device

62 control device

1.-13. (canceled)

14. A process for producing cement clinker, the process comprising:
preheating raw meal in a preheater;
calcining in a calciner the raw meal that has been preheated;
burning in a furnace the raw meal that has been preheated and calcined to give cement clinker;
supplying the furnace with a combustion gas having an oxygen content;
ascertaining a temperature within the furnace, wherein the supply of oxygen to the furnace is under closed-loop control as a function of the temperature ascertained within the furnace;
cooling the cement clinker in a cooler;
comparing the temperature with a target value and increasing or reducing the supply of oxygen to the furnace based on a variance of the temperature from the target value; and
adjusting the target value based on a particle size distribution and/or a lime standard.

15. The process of claim 14 wherein the temperature within the furnace is ascertained directly with a temperature measurement device or indirectly by way of process parameters that include at least one of a nitrogen oxide content in the furnace, a power consumption of the furnace, an oxygen content in the furnace, a fuel supply to the furnace, an outside temperature of a furnace wall, or a supply of raw meal to the preheater.

16. The process of claim 14 comprising adjusting the supply of oxygen to the furnace and to the calciner such that there is superstoichiometric combustion in the calciner and the furnace.

17. The process of claim 14 comprising supplying the furnace with a fuel, wherein the supply of fuel to the furnace is under closed-loop control as a function of the temperature ascertained within the furnace.

18. The process of claim 14 wherein the cooler has a cooling gas space through which a cooling gas stream for cooling bulk material flows in crossflow, wherein the cooling gas space comprises a first cooling gas space section with a first cooling gas stream and a second cooling gas space section that adjoins the latter in a conveying direction of the cement clinker and has a second cooling gas stream, wherein the combustion gas supplied to the furnace is formed by the first cooling gas stream, wherein the supply of the combustion gas is under closed-loop control as a function of the temperature ascertained within the furnace.

19. The process of claim 14 comprising introducing the combustion gas into the furnace through combustion gas inlets in the furnace, wherein the supply of the combustion gas to the respective combustion gas inlets is controlled in each case depending on the temperature ascertained within the furnace.

20. The process of claim 14 comprising ascertaining values of an amount of fuel applied to the furnace and the calciner, a proportion of nitrogen oxides in a furnace offgas, a proportion of oxygen in the furnace offgas, and an amount of raw meal applied to the preheater, wherein the oxygen supply to at least one of the furnace or the calciner is under closed-loop control as a function of at least one of the values ascertained.

21. The process of claim 14 wherein ascertaining the temperature within the furnace and/or a temperature at a material inlet to the furnace comprises ascertaining a temperature contactlessly of at least one of a gas phase, an inner wall surface, or the cement clinker within a sintering zone.

22. A cement production plant comprising:
a preheater configured to preheat raw meal;
a calciner configured to calcine the raw meal that has been preheated;
a furnace configured to burn the raw meal to give cement clinker, wherein the furnace includes:
a temperature measurement device for ascertaining a temperature within the furnace, and
a combustion gas inlet for introducing a combustion gas with an oxygen content into the furnace;
a cooler configured to cool the cement clinker;
a control device connected to the temperature measurement device and the combustion gas inlet and configured to control the supply of oxygen to the furnace depending on the temperature ascertained within the furnace, wherein the control device is configured to compare the temperature ascertained in the furnace with a target value and increase or decrease the supply of oxygen to at least one of the furnace or the calciner if the temperature that is ascertained varies from the target value,
wherein the cement production plant is configured such that the target value is adjusted depending on at least one of a particle size distribution and/or a lime standard.

23. The cement production plant of claim 22 wherein the preheater includes an oxygen measurement device, which is connected to the control device, for ascertaining an oxygen content of a gas flowing through the preheater, wherein the control device is configured to control the oxygen supply to the calciner and the furnace such that stoichiometric combustion is effected in the furnace and the calciner.

24. The cement production plant of claim 22 wherein the preheater includes an oxygen measurement device, which is connected to the control device, for ascertaining an oxygen content of a gas flowing through the preheater, wherein the control device is configured to control the oxygen supply to the calciner and the furnace such that superstoichiometric combustion is effected in the furnace and the calciner.

25. The cement production plant of claim 22 wherein the calciner and the furnace each have means for supplying fuel, respectively, to the furnace and to the calciner, wherein the control device is connected to the means for supplying fuel and configured to control the supply of fuel to the calciner and/or the furnace depending on the temperature ascertained within the furnace.

26. The cement production plant of claim 22 wherein the furnace has combustion gas inlets through which the combustion gas can be introduced into the furnace, wherein the control device is configured to control the supply of combustion gas to each of the respective combustion gas inlets depending on the temperature ascertained within the furnace.

27. The cement production plant of claim 22 wherein the temperature measurement device is configured to perform contactless temperature measurement on the cement clinker within a sintering zone.

28. The cement production plant of claim 22 wherein the temperature measurement device is configured to perform contactless temperature measurement on an inner surface of a furnace wall within a sintering zone.
